(19) United States
(12) Patent Application Publication
(10) Pub. No.: US 2025/0261074 A1
(43) Pub. Date: Aug. 14, 2025

(54) METHODS FOR MEASUREMENTS AND CPAC IN MULTI CONNECTIVITY

(71) Applicant: INTERDIGITAL PATENT HOLDINGS, INC., Wilmington, DE (US)

(72) Inventors: Martino Freda, Laval (CA); Oumer Teyeb, Montreal (CA); Benoit Pelletier, Roxboro (CA)

(73) Assignee: INTERDIGITAL PATENT HOLDINGS, INC., Wilmington, DE (US)

(21) Appl. No.: 18/702,422

(22) PCT Filed: Oct. 19, 2022
(86) PCT No.: PCT/US2022/047155

§ 371 Date: Apr. 18, 2024

Related U.S. Application Data
(60) Provisional application No. 63/257,340, filed on Oct. 19, 2021.
(60) Provisional application No. 63/354,094, filed on Jun. 21, 2022.

(51) Int. Cl. H04W 36/30; H04W 76/15

(52) U.S. Cl. CPC H04W 36/304; H04W 76/15

(57) ABSTRACT

In one or more embodiments, there may be a wireless transmit receive units (WTRU) that implements a method. For example, a WTRU may be configured with measurement events that consider multiple candidate and/or serving cells. Conditional PSCell Addition/Change (CPAC) may use measurement conditions configured with multiple cells. Measurement Event Conditions (e.g., values of X, Y) may depend on factors at the WTRU. The WTRU may determine the number of secondary nodes to add when triggering a conditional PSCell addition condition. The WTRU may determine whether to perform a conditional PSCell addition or change based on configured conditions. The WTRU may be configured with conditions to release an SN. The WTRU may stay between a range of configured SNs. The WTRU may indicate the SCGs added/changed following a CPAC.

### CROSS-REFERENCE TO RELATED APPLICATIONS

This application claims the benefit of U.S. Provisional Application No. 63/257,340, filed Oct. 19, 2021, and No. 63/354,094 filed Jun. 21, 2022, the contents of which are incorporated herein by reference.

### SUMMARY

In one or more embodiments, there may be a wireless transmit receive units (WTRU) that implements a method. For example, a WTRU may be configured with measurement events that consider multiple candidate and/or serving cells. Conditional PSCell Addition/Change (CPAC) may use measurement conditions configured with multiple cells. Measurement Event Conditions (e.g., values of X, Y) may depend on factors at the WTRU. The WTRU may determine the number of secondary nodes to add when triggering a conditional PSCell addition condition. The WTRU may determine whether to perform a conditional PSCell addition or change based on configured conditions. The WTRU may be configured with conditions to release an SN. The WTRU may stay between a range of configured SNs. The WTRU may indicate the SCGs added/changed following a CPAC.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to one or more embodiments;

FIG. 1C is a system diagram illustrating an example radio access network (RAN) and an example core network (CN) that may be used within the communications system illustrated in FIG. 1A according to one or more embodiments

FIG. 1D is a system diagram illustrating a further example RAN and a further example CN that may be used within the communications system illustrated in FIG. 1A according to one or more embodiments;

FIG. 2 is a diagram illustrating an example measurement model according to one or more embodiments;

FIG. 3 is a diagram illustrating an example of conditional handover (CHO) configuration and execution according to one or more embodiments;

FIG. 4 illustrates an example of a CPAC command configuration and action (e.g., add, replace, removed, changed, etc.); and

FIG. 5 illustrates an example of a CPAC configuration and action.

### DETAILED DESCRIPTION

One or more of the following acronyms may be used herein: Δf—Sub-carrier spacing; 5gFlex—5G Flexible Radio Access Technology; 5gNB—5GFlex NodeB; ACK—Acknowledgement; BLER—Block Error Rate; BRS—Beam Reference Signal; BTI—Basic TI (in integer multiple of one or more symbol duration); CB—Contention-Based (e.g. access, channel, resource); CHO—Conditional HandOver; COMP—Coordinated Multi-Point transmission/reception; CP—Cyclic Prefix; CP—OFDM Conventional OFDM (relying on cyclic prefix); CQI—Channel Quality Indicator; CN—Core Network (e.g. LTE packet core); CPAC—Conditional PSCell Addition/Change; CPC—Conditional PSCell Change; CRC—Cyclic Redundancy Check; CSG—Closed Subscriber Group; CSI—Channel State Information; CU—Central Unit; D2D—Device to Device transmissions (e.g., LTE Sidelink); DCI—Downlink Control Information; DL—Downlink; DM-RS—Demodulation Reference Signal; DRB—Data Radio Bearer; DU—Distributed Unit; EPC—Evolved Packet Core; FBMC—Filtered Band Multi—Carrier; FBMC/OQAM-A FBMC technique using Offset Quadrature Amplitude Modulation; FDD—Frequency Division Duplexing; FDM—Frequency Division Multiplexing; ICC—Industrial Control and Communications; ICIC—Inter-Cell Interference Cancellation; IP—Internet Protocol; LAA—License Assisted Access; LBT—Listen-Before-Talk; LCH—Logical Channel; LCP—Logical Channel Prioritization; LLC—Low Latency Communications; LTE—Long Term Evolution e.g. from 3GPP LTE R8 and up; MAC—Medium Access Control; NACK—Negative ACK; MC—MultiCarrier; MCG—Master Cell Group; MCS—Modulation and Coding Scheme; MIMO—Multiple Input Multiple Output; MTC—Machine-Type Communications; NAS—Non-Access Stratum; NR—New Radio; OFDM—Orthogonal Frequency-Division Multiplexing; OOB—Out-Of-Band (emissions); P_{cmax}—Total available UE power in a given TI; Pcell—Primary cell of Master Cell Group; PHY—Physical Layer; PRACH—Physical Random Access Channel; PDU—Protocol Data Unit; PER—Packet Error Rate; PLMN—Public Land Mobile Network; PLR—Packet Loss Rate; PScell—Primary cell of a Secondary cell group; PSS—Primary Synchronization Signal; QoS—Quality of Service (from the physical layer perspective); RAB—Radio Access Bearer; RAN PA—Radio Access Network Paging Area; RACH—Random Access Channel (or procedure); RAR—Random Access Response; RCU—Radio access network Central Unit; RF—Radio Front end; RLF—Radio Link Failure; RLM—Radio Link Monitoring; RNTI—Radio Network Identifier; RRC—Radio Resource Control; RRM—Radio Resource Management; RS—Reference Signal; RTT—Round-Trip Time; SCG—Secondary Cell Group; SCMA—Single Carrier Multiple Access; SDU—Service Data Unit; SOM—Spectrum Operation Mode; SpCell—Primary cell of a master or secondary cell group; SS—Synchronization Signal; SSS—Secondary Synchronization Signal; SRB—Signaling Radio Bearer; SWG—Switching Gap (in a self-contained subframe); TB—Transport Block; TBS—Transport Block Size; TDD—Time-Division Duplexing; TDM—Time-Division Multiplexing; TI—Time Interval (in integer multiple of one or more BTI); TTI—Transmission Time Interval (in integer multiple of one or more TI); TRP—Transmission/Reception Point; TRPG—Transmission/Reception Point Group; TRx—Transceiver; UFMC—Universal Filtered Multicarrier; UF—OFDM-Universal Filtered OFDM; UL—Uplink; URC—Ultra-Reliable Communications; URLLC—Ultra-Reliable and Low Latency Communications; V2V—Vehicle to vehicle communications; V2X—Vehicular communications; WLAN—Wireless Local Area Networks and related technologies (IEEE 802.xx domain).

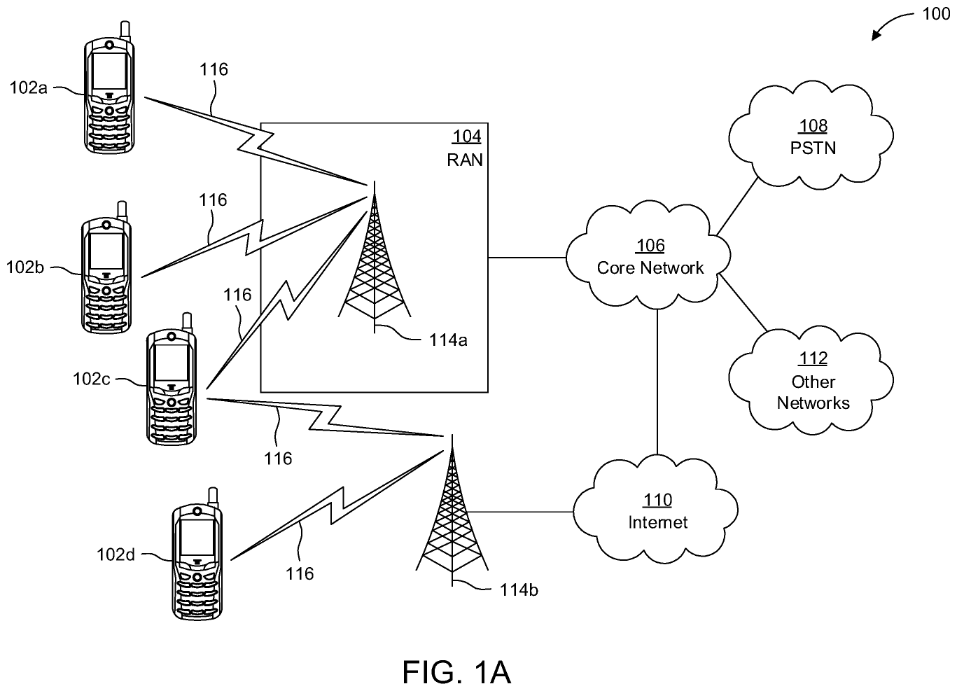

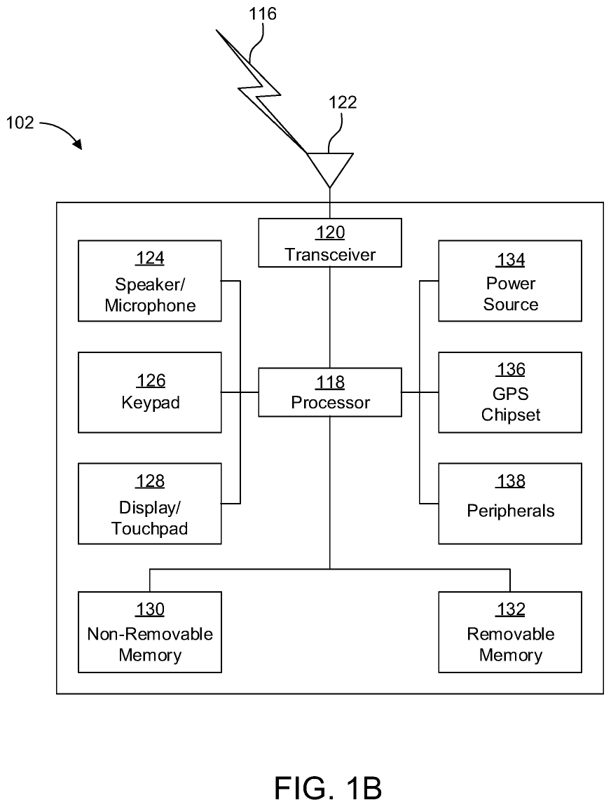

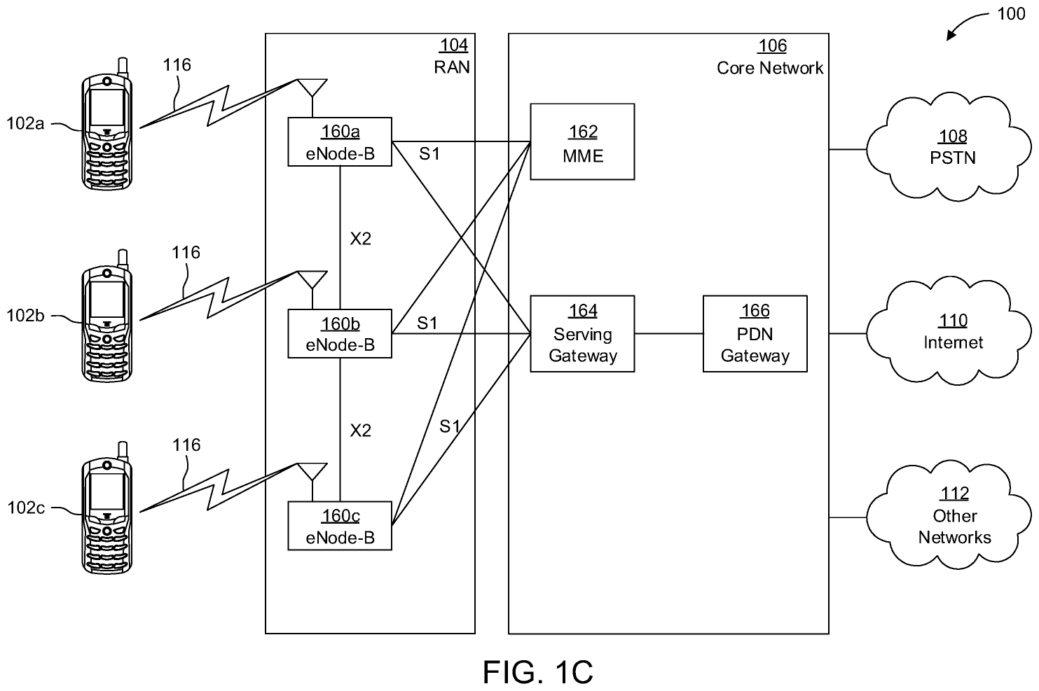

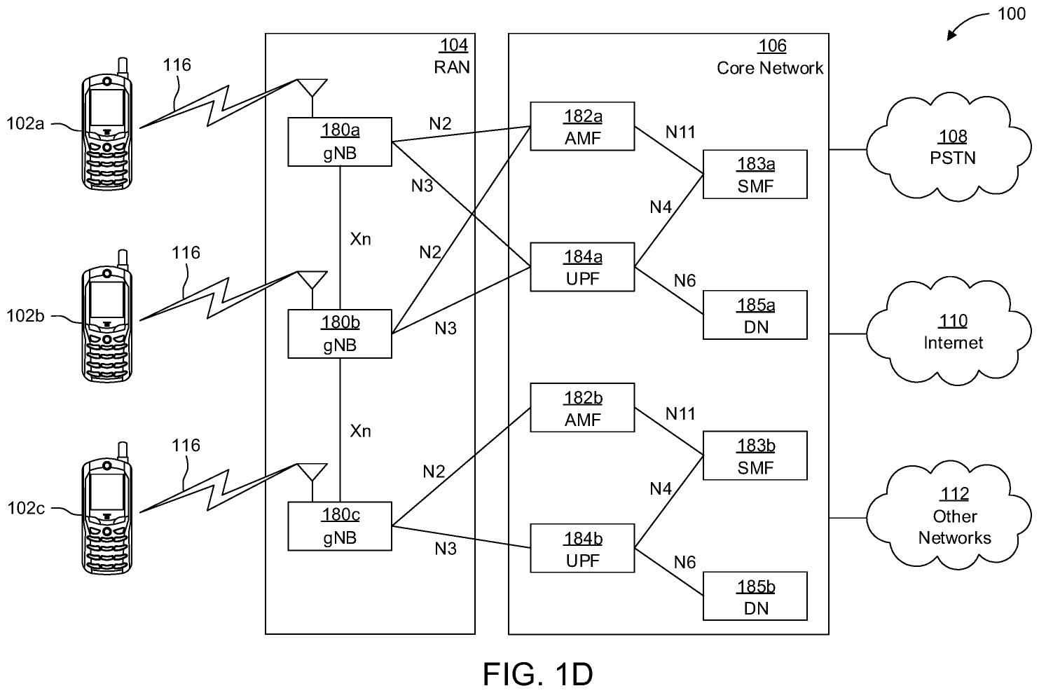

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHZ, 2 MHZ, 4 MHZ, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

As described herein, the techniques and examples described herein may apply to other wireless technologies and/or to wireless technology using different principles, when applicable. The term network in this disclosure may refer to one or more base stations (e.g., gNBs) which in turn may be associated with one or more Transmission/Reception Points (TRPs) or any other node in the radio access network. The term MR-DC (Multi-Radio Dual Connectivity) may indicate a Dual Connectivity between two different wireless technologies/systems, such as between E-UTRA and NR nodes, or between two NR nodes.

Regarding multi-connectivity, generally, a WTRU may be configured to utilize resources provided by two or more different nodes connected via non-ideal backhaul, wherein the nodes may provide access using the same or different Radio Access Technologies (RATs). One node may act as the Master Node (MN) controlling the resources associated with one or more cells called the Master Cell Group (MCG) and another node may act as the Secondary Node (SN), controlling resources associated with cells of the second cell group (SCG). The MN and SN may be connected via a network interface, as described herein, and at least the MN is connected to the core network.

In the case of dual connectivity, the WTRU may be configured with two MAC entities. One MAC entity for the MCG and one MAC entity for the SCG.

The WTRU may be configured to receive and process one or more RRC reconfiguration messages via the MCG, where the reconfiguration may result in SCG addition, change/modification, or release.

Regarding measurements in NR, when a WTRU is in an RRC_CONNECTED mode or state, the WTRU may measure one or more beams of a cell and the resulting measurements (e.g., power values) may be averaged to derive the cell quality. In doing so, the WTRU may be configured to consider a subset of the detected beams. Filtering may take place at two different levels: at the physical layer to derive beam quality and then at the RRC level to derive cell quality from multiple beams. Cell quality from beam measurements may be derived in the same or similar method for both the serving cell(s) and for the non-serving cell(s). Measurement reports, sent by the WTRU after taking measurements, may contain the measurement results of a number (e.g., X) of best beams if the WTRU is configured to do so by the base station.

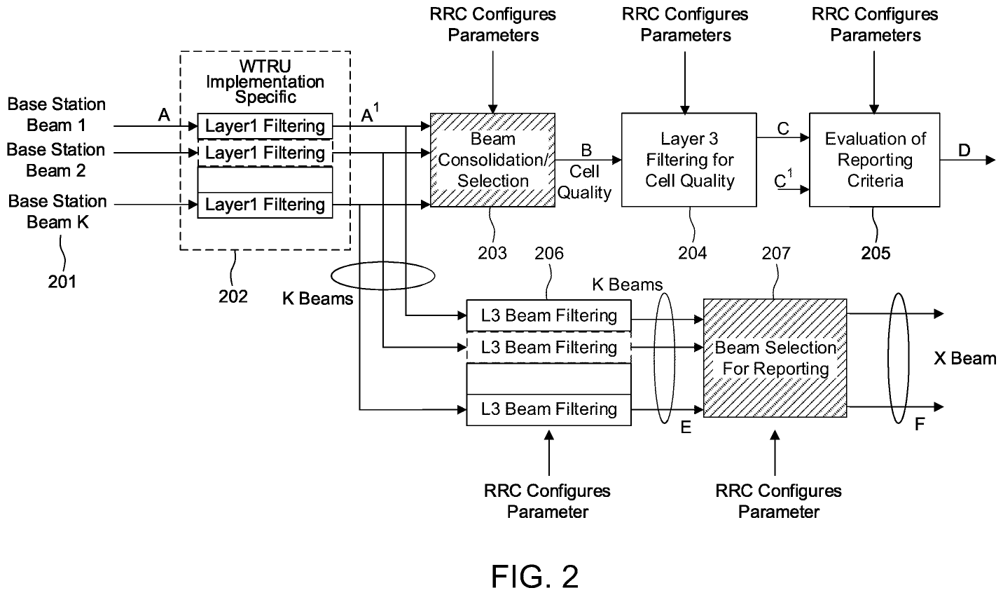

FIG. 2 illustrates an example of a measurement model. Generally, the model may be read for right to left, starting at the base stations 1 through K (e.g., at 201). One or more of the features of this example may be performed by a WTRU.

At point A, there may be measurements (e.g., beam-specific samples of the K beams from the base stations) internal to the physical layer.

At 202, Layer 1 (L1) filtering may be performed on the inputs (e.g., K beams) measured at point A. Exact filtering may be implementation dependent. How the measurements are actually executed in the physical layer (e.g., inputs A and Layer 1 filtering) may be implementation specific. Note, that the K beams may correspond to the measurements on SSB or CSI-RS resources configured for Layer 3 (L3) mobility by a base station and detected by WTRU at L1.

At, point A¹, measurements (e.g., beam-specific measurements of the K beams from the base stations) may be reported by Layer 1 to Layer 3 (L3) after the Layer 1 filtering.

At 203, beam consolidation and/or selection may be performed, where beam-specific measurements may be consolidated to derive cell quality (e.g., measured at B). The behavior of the beam consolidation/selection may be standardized and the configuration of this module may be provided by RRC signaling (e.g., configuration parameters). The resulting reporting period, at B, may equal one measurement period at A¹.

At point B, measurements (e.g., of cell quality) may be derived from beam-specific measurements reported to Layer 3 after beam consolidation/selection.

At 204, Layer 3 filtering for cell quality may be performed, which is filtering performed on the measurements taken at point B. The behavior of the Layer 3 filters may be standardized and the configuration of the Layer 3 filters may be provided by RRC signaling (e.g., configuration parameters).

At point C, there may be an RSRP/Cell Quality measurement after the Layer 3 filtering. The reporting rate may be the same/similar to the reporting rate at point B (e.g., the filtering reporting period at C equals one measurement period at B). This measurement may be used as input for one or more evaluations of reporting criteria.

At 205, a determination may be made regarding whether to report the information measured/evaluated. This may include the evaluation of reporting criteria, which determines checks of whether actual measurement reporting (e.g., point D) is necessary. In some instances, the evaluation may be based on more than one flow of measurements at reference point C (e.g., to compare between different measurements). In this instance, more than one flow is illustrated by the two inputs C and C¹, although in other instances there may be more or less. The WTRU may evaluate the reporting criteria at least every time a new measurement result is reported at point C, C¹ (e.g., C¹ may include cell quality associated with other cells other than the cell in question). The reporting criteria may be standardized and the configuration may be provided by RRC signaling (e.g., configuration parameters, regarding WTRU measurements).

At point D, measurement report information (e.g., in a message) may be sent on the radio interface.

Returning back to after the measurements at point A1, in some cases, at 206 L3 Beam filtering may be performed, which includes filtering the measurements (e.g., beam-specific measurements) provided at point A1. The behavior of the beam filters may be standardized and the configuration of the beam filters may be provided by RRC signaling (e.g., configuration parameters).

At point E, measurement (e.g., beam-specific measurement of K beams) may be performed after processing in the beam filter. The reporting rate may be the same or similar to the reporting rate at point A1 (e.g., The filtering reporting period at E may equal one measurement period at A1). This measurement may be used as input for selecting the X measurements to be reported.

At 207, beam selection may be performed for beam reporting, where X measurements from the measurements provided at point E may be selected. The behavior of the beam selection may be standardized and the configuration of this module may be provided by RRC signaling (e.g., configuration parameters).

At point F, measurement information (e.g., of the X selected measurements of X beams) may be reported (e.g., sent) on the radio interface.

Layer 1 filtering may provide a certain level of measurement averaging. How and when the WTRU exactly performs the required measurements may be implementation specific to the point that the output at B fulfills the performance requirements of one or more preconfigured thresholds. Layer 3 filtering for cell quality and related parameters may be used and may not introduce any delay in the sample availability between B and C. Measurements at point C and/or C¹ may be the input used in the event evaluation. L3 beam filtering and related parameters used may be preconfigured and may not introduce any delay in the sample availability between points E and F.

Measurement reports may adhere to one or more of the following: measurement reports may include the measurement identity of the associated measurement configuration that triggered the reporting; cell and beam measurement quantities may be included in measurement reports that are configured by the network; a number of non-serving cells to be reported may be limited through configuration by the network; cells belonging to a blacklist configured by the network may not be used in event evaluation and reporting, and conversely when a whitelist is configured by the network, only the cells belonging to the whitelist may be used in event evaluation and reporting; and/or, beam measurements to be included in measurement reports may be configured by the network (e.g., beam identifier only, measurement result and beam identifier, or no beam reporting).

There may be one or more intra-frequency neighbor (cell) measurements and inter-frequency neighbor (cell) measurements.

For example, a measurement may be defined as an SSB-based intra-frequency measurement provided the center frequency of the SSB of the serving cell and the center frequency of the SSB of the neighbor cell are the same, and the subcarrier spacing of the two SSBs is also the same. A measurement may be defined as an SSB-based inter-frequency measurement provided the center frequency of the SSB of the serving cell and the center frequency of the SSB of the neighbor cell are different, or the subcarrier spacing of the two SSBs is different. Note, for SSB-based measurements, one measurement object may correspond to one SSB and the WTRU may consider different SSBs as different cells.

For example, a measurement may be defined as a CSI-RS-based intra-frequency measurement provided that: the SCS of CSI-RS resources on the neighbor cell configured for measurement is the same as the SCS of CSI-RS resources on the serving cell indicated for measurement; for SCS=60 kHz, the CP type of CSI-RS resources on the neighbor cell configured for measurement is the same as the CP type of CSI-RS resources on the serving cell indicated for measurement; and, the center frequency of CSI-RS resources on the neighbor cell configured for measurement is the same as the center frequency of CSI-RS resource on the serving cell indicated for measurement. In one instance, a measurement may be defined as a CSI-RS-based inter-frequency measurement if it is not a CSI-RS-based intra-frequency measurement. Note, extended CP for CSI-RS-based measurement may not be supported in some examples.

Whether a measurement is non-gap-assisted or gap-assisted may depend on the capability of the WTRU, the active BWP of the WTRU, and/or the current operating frequency. For SSB-based inter-frequency measurement, if the measurement gap requirement information is reported by the WTRU, a measurement gap configuration may be provided according to the information. Otherwise, a measurement gap configuration is always provided in the following cases: if the WTRU only supports per-WTRU measurement gaps; and/or, if the WTRU supports per-FR measurement gaps and any of the serving cells are in the same frequency range of the measurement object. For SSB-based intra-frequency measurement, if the measurement gap requirement information is reported by the WTRU, a measurement gap configuration may be provided according to the information. Otherwise, a measurement gap configuration is always provided in the following case: other than the initial BWP, if any of the WTRU-configured BWPs do not contain the frequency domain resources of the SSB associated with the initial DL BWP.

The measurement reporting configuration may be either event-triggered or periodical. If it is periodical, the WTRU sends the measurement report every reporting interval (e.g., range between 120 ms and 30 min).

For event-triggered measurements, the WTRU may send the measurement report when the conditions associated with the event are fulfilled. After the event is triggered and the WTRU reports measurement(s), the WTRU may keep on measuring the serving cell and the neighbors, and report these measurements. Further, the WTRU may continue to evaluate the measurements based on a threshold and/or offset defined in the report configuration. The report and/or the trigger event may be RSRP, RSRQ and/or SINR.

In some cases, there may be one or more intra-RAT events. One example intra-RAT event may be where serving becomes better than a threshold (e.g., event A1). Event A1 may be used to cancel an ongoing handover procedure. This may be required if a WTRU moves toward the cell edge and triggers a mobility procedure, but then subsequently moves back into good coverage before the mobility procedure has been completed.

One example intra-RAT event may be where serving becomes worse than a threshold (e.g., event A2). Since it does not involve any neighbor cell measurements, A2 may be used to trigger a blind mobility procedure, or the network may configure the WTRU for neighbor cell measurements when it receives a measurement report that is triggered due to event A2 in order to save WTRU battery (e.g., not perform neighbor cell measurement when the serving cell quality is good enough).

One example intra-RAT event may be where a neighbor becomes offset better than SpCell (e.g., event A3). Event A3 may be used for a handover procedure. Note, an SpCell (special cell) may be the primary serving cell of either the Master Cell Group (MCG) (e.g., the PCell), or Secondary Cell Group (SCG) (e.g., the primary and secondary cells (PSCell). Thus, in a dual connectivity operation, the Secondary Node (SN) may configure an A3 event for SN-triggered PSCell change.

One example intra-RAT event may be where a neighbor becomes better than a threshold (e.g., event A4). Event A4 may be used for handover procedures that do not depend upon the coverage of the serving cell (e.g., load balancing, where the WTRU is handed over to a good neighbor cell even if the serving cell conditions are excellent).

One example intra-RAT event may be where SpCell becomes worse than a first threshold and the neighbor becomes better than a second threshold (e.g., event A5). Like A3, this is may be used for handover, but unlike A3, it provides a handover triggering mechanism based upon absolute measurements of the serving and neighbor cell, while A3 uses a relative comparison. As such, it may be suitable for time-critical handover when the serving cell becomes weak and it is necessary to change towards another cell that may not satisfy the criteria for an event A3 handover.

One example intra-RAT event may be where a neighbor becomes offset better than SCell (e.g., event A6): This may be used for SCell addition/releasing.

In some cases, there may be one or more inter-RAT events. One example inter-RAT event may be where an inter-RAT neighbor becomes better than a threshold (e.g., event B1). This may be equivalent to A4, but for the case of inter-RAT handover. One example inter-RAT event may be where the PCell becomes worse than a first threshold and the inter-RAT neighbor becomes better than a second threshold (e.g., event B2). This may be equivalent to A5, but for the case of inter-RAT handover.

The WTRU's measurement configuration may contain an s-measure configuration (s-MeasureConfig), which specifies a threshold for a NR SpCell RSRP measurement controlling when the WTRU is required to perform measurements on non-serving cells. The value may be a threshold corresponding to SSB-RSRP (e.g., corresponding to cell RSRP based on SS/PBCH block) or a choice of CSI-RSRP (e.g., corresponding to cell RSRP of CSI-RS). If the measured SpCell SSB or CSI-RSRP is above the threshold, the WTRU will not perform measurements on non-serving cells, improving WTRU power consumption (e.g., WTRU does not perform unnecessary measurements if it has very good radio conditions towards the serving cells).

In some cases, there may be conditional handover (CHO) and conditional PSCell Addition/Change (CPA/CPC, or collectively referred to as CPAC), with the main aim of reducing the likelihood of radio link failures (RLF) and handover failures (HOF).

In some cases, handover may be triggered by measurement reports, even though there is nothing preventing the network from sending a HO command to the WTRU even without receiving a measurement report. For example, the WTRU is configured with an A3 event that triggers a measurement report to be sent when the radio signal level/quality (e.g., RSRP, RSRQ, etc.) of a neighbor cell becomes better than the Primary serving cell (PCell) or also the Primary Secondary serving Cell (PSCell), in the case of Dual Connectivity (DC). The WTRU may monitor the serving and neighbor cells and may send a measurement report when the conditions get fulfilled. When such a report is received, the network (e.g., current serving node/cell) may prepare the HO command (e.g., an RRC Reconfiguration message, with a reconfigurationWithSync) and sends it to the WTRU, which the WTRU executes immediately resulting in the WTRU connecting to the target cell.

CHO may differ from the above handover in one or more aspects: multiple handover targets may be prepared (e.g., as compared to only one target in the above case); and/or, the WTRU may not immediately execute the CHO, but instead, the WTRU may be configured with triggering conditions (e.g., a set of radio conditions), and the WTRU executes the handover towards one of the targets only when/if the triggering condition(s) are fulfilled.

The CHO command may be sent when the radio conditions towards the current serving cells are still favorable, thereby reducing two possible points of failure in some cases of handover, such as the risk of failing to send the measurement report (e.g., if the link quality to the current serving cell falls below acceptable levels when the measurement reports are triggered in normal handover) and the failure to receive the handover command (e.g., if the link quality to the current serving cell falls below acceptable levels after the WTRU has sent the measurement report, but before it has received the HO command).

The triggering conditions for a CHO may also be based on the radio quality of the serving cells and neighbor cells like the conditions that are used in some HO cases to trigger measurement reports. For example, the WTRU may be configured with a CHO that has an A3-like triggering condition and associated HO command. The WTRU monitors the current serving cells and when the A3 triggering conditions are fulfilled, it will, instead of sending a measurement report, execute the associated HO command and switch its connection toward the target cell.

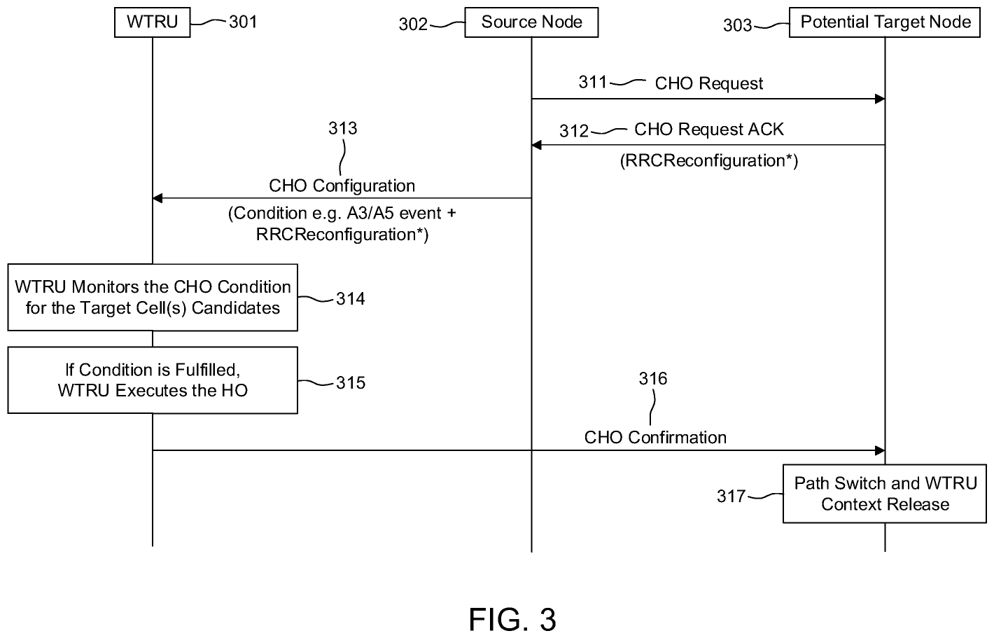

FIG. 3 is an illustration of an example of conditional handover (CHO) configuration and execution. As shown, there may be a WTRU 301, a source node 302, and a potential target node 303. At 311 there may be a conditional handover (CHO) request sent from the source node 302 to the potential target node 303. At 312, there may be a CHO request acknowledgment (ACK) sent from the potential target node 303 to the source node (e.g., an RRCReconfiguration may be included/part of the ACK comprising information regarding the requested CHO). The asterisk as shown may represent that the reconfiguration may be transparently included as a container in the message. At 313, a CHO configuration may be sent from the source node 302 to the WTRU 301 (e.g., the CHO configuration may comprise one or more conditions, such as event A3/A5 plus something defined in the RRCReconfiguration). At 314, the WTRU 301 may monitor the CHO condition for the target cell(s) candidates (e.g., potential target node). At 315, the WTRU may determine that a condition is met, and execute the handover. At 316, there may be a CHO confirmation toward the potential target node 303. At 317, the potential target node may perform a path switch, and the WTRU context may be released; explained another way, the path switch may be between the source and target, while the context release may be at the source.

Another benefit of CHO is in helping prevent unnecessary re-establishments in case of a radio link failure. For example, assume the WTRU is configured with multiple CHO targets and the WTRU experiences an RLF before the triggering conditions with any of the targets are met. A non-optimal operation may have resulted in RRC re-establishment procedure that would have incurred considerable interruption time for the bearers of the WTRU. However, in the case of CHO, if the WTRU, after detecting an RLF, ends up a cell for which it has a CHO associated with (e.g., the target cell may already be prepared for it), the WTRU may execute the HO command associated with this target cell directly, instead of continuing with the full re-establishment procedure.

CPC and CPA may be just extensions of CHO, but in DC scenarios. A WTRU may be configured with triggering conditions for PSCell change or addition, and when the triggering conditions are fulfilled, it may execute the associated PSCell change or PSCell add commands.

For UL transmission in DC, a WTRU in multi-RAT DC having one or more split bearers may be configured with a split bearer threshold. The split bearer threshold may be used to determine the data transmission to each leg of the split bearer by the WTRU. Specifically, the PDCP layer may route data to either MCG or both MCG and SCG based on the split bearer threshold. If the amount of data available for a bearer exceeds the split bearer threshold, the WTRU may route data for that bearer either to MCG or SCG. Otherwise, the WTRU may send data for that bearer to MCG only.

In some cases, the WTRU may be configured with two separate schedulers (e.g., MN and SN), where one scheduler or cell group is considered to be the master node or the RRC anchor, and the other scheduler provides bandwidth extension, on the same or different RAT.

With use cases and applications such as Extended Reality (XR) that require larger bandwidths, multi-connectivity (e.g., the ability for the WTRU to be scheduled by multiple SNs) may be needed. This ability at the WTRU may also increase the flexibility of the network to configure the WTRU with multiple collocated or non-collocated nodes/base stations to boost the WTRUs bandwidth at specific times.

In some cases, CPA (Conditional PSCell Addition) and CPC (Conditional PSCell Change/Modification) may be used to add or modify an SN based on a measurement condition. These procedures may be used for a dual connectivity architecture-namely a WTRU that is configured with a single MN and a single SN. There is a need to improve upon and extend these procedure(s) (e.g., defining measurement events, SN configuration, etc.) for the case of multi-connectivity.

To address the above, there may be methods for measurements and CPAC in WTRU multi-connectivity with multiple SNs. This may include measurement events that consider multiple PSCells.

In some cases, a WTRU may be configured with measurement events that consider multiple candidates and/or serving cells. The WTRU may be configured with new measurement event conditions that consider multiple candidate cells, multiple serving cells, or both multiple candidate cells and serving cells. For example, the WTRU may be configured with one or more measurement event conditions, such as conditions on the quality of neighbor cells/serving cells, and/or conditions on the number of neighboring cells/serving cells.

For conditions on the quality of neighboring cells/serving cells, there may be events similar to and/or the same as A1/A2, where: all serving cells become better/worse than a threshold; at least one serving cell becomes better/worse than a threshold; at least X serving cells (or X % of serving cell) become better/worse than a threshold; a first serving cell becomes better/worse than a first threshold, a second serving cell becomes better/worse than a second threshold, and so on until an N serving cell becomes better/worse than an N threshold; and/or, a first serving cell becomes better/worse than a first threshold, and a second serving cell becomes worse/better than a second threshold.

For conditions on the quality of neighboring cells/serving cells, there may be events similar to and/or the same as A3, where: a neighbor cell becomes an offset better than all serving cells; a neighbor cell becomes an offset better than at least one serving cell; a neighbor cell becomes an offset better than at least X serving cells (or X % of serving cells); at least X neighbor cells (or X % of neighbor cells) become an offset better than all serving cells; and/or, at least X neighbor cells (or X % of neighbor cells) become an offset better than at least one serving cell; at least X neighbor cells (or X % of neighbor cells) become an offset better than at least Y (or Y % of) serving cells.

For conditions on the quality of neighboring cells/serving cells, there may be events similar to and/or the same as A4, where: at least X neighbor cells (or X % of neighbor cells) become better than a threshold; and/or, at least X neighbor cells (or X % of neighbor cells) become better than a first threshold and at least Y neighbor cells (or Y % of neighbor cells) become better than a second threshold, and so on.

For conditions on the quality of neighboring cells/serving cells, there may be events similar to and/or the same as A5, where: at least one serving cell becomes worse than a first threshold, and at least one neighbor cell becomes better than a second threshold; at least X serving cells (or X % of serving cells) become worse than a first threshold, and at least Y neighbor cells (or Y % of neighbor cells) become better than a second threshold; and/or, at least X serving cells (or X % of serving cells) become worse than a first threshold and at least Y serving cells (or Y % of serving cells) become worse than a second threshold, and so on, and at least Z neighbor cells (or Z % of neighbor cells) become better than a third threshold and at least W neighbor cells (or W % of neighbor cells) become better than a fourth threshold, and so on.

For conditions on the number of neighboring cells/serving cells, there may be events similar to and/or the same as A1/A2/A4, where: the number (or percentage) of neighbor cells with quality above/below a threshold is larger than X (or X %); and/or, the number (or percentage) of serving cells with quality above/below a threshold is larger than X (or X %).

For conditions on the number of neighboring cells/serving cells, there may be events similar to and/or the same as A3, where: the number (or percentage) of neighbor cells with quality an offset better than all serving cells is larger than X (or X %); the number (or percentage) of neighbor cells with quality an offset better than at least one serving cell is larger than X (or X %); and/or, the number (or percentage) of neighbor cells with quality an offset better than at least Y serving cells is larger than X (or X %).

For conditions on the number of neighboring cells/serving cells, there may be events similar to and/or the same as A5, where: the number (or percentage) of serving cells worse than a threshold is larger than X (or X %) and the number (or percentage) of neighbor cells better than another threshold is larger than Y (or Y %); and/or, the number of serving cells worse than a threshold is larger/smaller than the number of serving cells greater than a threshold.

In some instances, a WTRU may be configured with an event that comprises of a combination of any of the elements of any of the events disclosed herein. In one, instance, the configuration may comprise more than one of the disclosed events. In one instance, the configuration may be one or another event.

In some cases, a WTRU may determine which serving cells the measurement event configuration is applicable for. In one case, in the event configurations disclosed herein, the WTRU may consider a serving cell to be any serving cell (e.g., PCell, PSCell, SCell of an MCG, SCell of an SCG).

In one case, in the event configurations disclosed herein, a WTRU may consider a serving cell to be an SPCell (e.g., PCell or PSCell)

In one case, in the event configurations disclosed herein, a WTRU may consider a serving cell to be an SCell of the MCG.

In one case, in the event configurations disclosed herein, a WTRU may consider a serving cell to be an SCell of the SCG.

In one case, in the event configurations disclosed herein, a WTRU may implicitly determine what the serving cell is based on the event type (e.g., the serving cell is the PCell or PSCell for A3/A5 events, serving cell is an SCell for A1/A2).

In one case, an indication may be included in the event configuration to explicitly identify the concerned serving cell (e.g., the serving cell/cells ID/IDs explicitly indicated in the event configuration).

In one case, when the WTRU has more than one SCG, the different SCGs may be identified with different serving cell group IDs (e.g., 2, 3, 4, . . . ), the measurement event configuration received from the MCG may explicitly indicate to which SCG (or SCGs) this event configuration is relevant to. For example, the WTRU may have two SCGs, with IDs 2 and 3, and the network may send one CPC configuration that includes an identification of the second SCG, which informs the WTRU, for example, that the thresholds of an A3-like event that is in the CPC configuration are to be used to compare the PSCell of the second SCG with a neighbor cell.

In one case, when the WTRU has more than one SCG, where no ID of an SCG (or SCGs) is included, then the WTRU may interpret that the event thresholds included in the CPC comparison are applicable to all of the PSCells, and the CPC is to be executed if the condition of one of the PSCells and a neighbor cell fulfill the event triggering conditions. If, for example, when the conditions are fulfilled for a neighbor cell and the PSCell of the first SCG for an A3/A5 event, this may result in the execution of the CPC and the release of the first PSCell (SCG) and replacement with the candidate neighbor that fulfilled the CPC triggering condition.

In one case, the WTRU may be provided with a list of SCGs (e.g., SCG IDs) for which to apply the disclosed herein behavior (e.g., the event is associated with SCGs with IDs 2 or 5).

In one case, when the WTRU has more than one SCG, where no ID of an SCG (or SCGs) is included, then the WTRU may interpret that the event thresholds included in the CPC comparison are to be applicable to all of the PSCells, and the CPC is to be executed if the condition of all the PSCells and a neighbor cell fulfill the event triggering conditions. If, for example, when the conditions are fulfilled for a neighbor cell and all the PSCells for an A3/A5 event, this may result in the execution of the CPC and the release of all the current PSCells (SCGs) and replacement with the candidate neighbor that fulfilled the CPC triggering condition.

In one case, the WTRU may be provided with a list of SCGs (e.g., SCG IDs) for which to apply the disclosed herein behavior (e.g., the event is associated with SCGs with IDs 2 and 5).

In some cases, a CPAC may use measurement conditions configured with multiple cells. The WTRU may be configured with CPAC, where the trigger to perform CPAC may be any of the conditions described herein that deal with multiple candidate neighbor/serving cells. For example, the WTRU may be configured with a CPA candidate, and a condition to add the candidate if at least X serving cells become worse than a threshold. As another example, the WTRU may be configured with a CPA candidate, and a condition to add the candidate if the candidate is better than at least X serving cells (by more than a certain threshold).

In some cases, Measurement Event Conditions (MECs) (e.g., values of X, Y) may depend on factors at the WTRU. New events considering the measurements of multiple candidate cells (e.g., as described herein) may have parameters that depend on the conditions at the WTRU at the time of an event. Specifically, the WTRU may be configured with measurement event conditions on the number/percentage of cells, where the thresholds for triggering these conditions (e.g., values of X, Y) may further depend on conditions at the WTRU, such as: load (e.g., amount of buffered UL/DL data at the WTRU); number of split bearers, or number of bearers that can use the candidate cells as the SCG; and/or, power savings preference at the WTRU at a given time (e.g., the WTRU may be in one of a number of power savings preferences, and may determine the values of X/Y in the measurement conditions based on the current power savings preference).

In some cases, a WTRU may determine the number of SNs to add when triggering a CPA condition. In one case, a WTRU may be configured with a CPA condition. When the CPA condition is triggered, the WTRU may further determine the number of SNs to add. Such a number may be determined by the WTRU based on: the number of SNs already configured (e.g., the WTRU may be configured with a maximum number of configured SNs, and may add SNs following the trigger of a CPA only up to the maximum); the number of SNs associated with the condition itself (e.g., the WTRU may be configured with a condition whereby the number of neighbor cells above a threshold is larger than X; the WTRU may then add X SNs using a CPA operation); the relative measurements of the SNs configured (e.g., the WTRU may determine the number of SNs to add based on the relative measurements between the SNs; e.g., the WTRU may be configured with a number of SNs in the CPA command and may determine which of the SNs to add based on the relative measurements between the best SN and the other SNs; specifically, if the best SN is an offset better than all other SNs, only the best SN is added, otherwise, the WTRU can add all the SNs configured in the CPA command, or all the SNs for which the conditions was triggered); and/or, the load on one/more/all of the WTRU's radio bearers at the time of the CPA (e.g., the WTRU may be configured with multiple CPA candidates in a CPA command; the WTRU may add a number of SNs based on the load of one or more bearers which are configured to use the one or more candidates; if the amount of data pending for transmission is within a first range, the WTRU may add 1 SN, of the amount of data pending for transmission is within a second range, the WTRU May 2 SNs, and so on).

In some cases, a WTRU determines whether to perform a CPA or a CPC based on configured conditions. In one case, when the WTRU already has one or more SCGs, the CPAC configuration may contain an explicit indication of whether the configuration is for CPA or for CPC.

In one case, a WTRU may be configured with a CPA/CPC command, and the WTRU may determine whether to perform either CPA or CPC based on one or more conditions at the WTRU.

One CPA/CPC condition may depend on the number of SNs already configured. For example, the WTRU may be configured with a maximum number of configured SNs, and may perform a CPC if it has already reached the maximum number of SNs, or a CPA otherwise. For example, the maximum number of configured SNs may be determined by the UE based on similar rules described for determining the number of SNs to add. Specifically, the WTRU may be configured with a maximum number of SNs which is determined based on an average buffer occupancy. Specifically, the WTRU may be configured with a maximum number of SNs for a given measured average buffer occupancy. If the WTRU has reached its maximum number of configured SNs based on buffer occupancy upon triggering of a condition, the WTRU may perform CPC, otherwise, it may perform CPA.

One CPA/CPC condition may depend on the relative measurements between the neighbor cell and the serving cells. For example, the WTRU may be configured to perform CPC if at least one of the neighbor cells that triggered the CPA/CPC condition is an offset better than any of the current PSCells, otherwise, the WTRU may perform CPA. The number of cells added may further depend on other factors described herein.

One CPA/CPC condition may depend on the buffer/load at the WTRU. For example, if the load at the WTRU is larger than a threshold, the WTRU may perform CPA, otherwise, it may perform CPC.

In some cases, a WTRU may be configured with a condition to release a secondary node (SN). Such a release operation may comprise of releasing the RRC configuration associated with a PSCell, such as would occur upon reception of a reconfiguration message where a release of a cell group is received. Additionally/alternatively, such a release operation may comprise a deactivation of an activated SN/PSCell. Additionally/alternatively, such a release operation may comprise of removal of an SN from a potential L1/L2 mobility target.

A WTRU may be configured with any of the conditions described herein for the release of an SN. Such conditions may be based on measurements and measurement events that compare the SN in question, possibly with a threshold, and/or possibly with one or more other SNs and/or MN. Such conditions may be based on buffer load, bearer configuration, or similar. For example, a WTRU may release an SN if the total buffer occupancy is below a threshold, possibly for a given bearer configuration. For example, a WTRU may release an SN if the amount of resources scheduled on an SN (e.g., over a period of time) is below a threshold.

A WTRU that releases an SN may maintain that SN as a potential CPC/CPA candidate. Specifically, an SN that is initially added following CPA/CPC may then be released based on a conditional release operation. The SN may then be re-added based on a similar conditional operation where the WTRU may use the original CPA/CPC command that configured the SN as a candidate when again considering that SN as a candidate for CPC/CPA. Alternatively, a WTRU may assume an SN is no longer reused as a candidate when it is released by a conditional operation. In another instance, a WTRU may determine whether an SN can be considered as a candidate for CPA/CPC following a conditional release based on a condition.

For example, there may be a condition that is based on how the SN was added. If the SN was added using a CPA, the SN may be reconsidered as a candidate for CPA/CPC, possibly using the same CPA/CPC configuration. Otherwise, if the SN was added by an explicit RRC reconfiguration message, the SN can no longer be used as a candidate.

For example, there may be a condition based on the number of configured SNs and/or the number of configured candidates. If the number of configured SNs or the number of configured candidates is below a threshold at the time of the release, the SN can be considered as a future candidate for CPA/CPC.

For example, there may be a condition that is based on the quality of the configured SN at the time of the release. If the measured quality of the SN is above a threshold at the time of the release, the SN can be considered as a future candidate for CPA/CPC.

In some cases, a WTRU may stay between a range of configured SNs. In combination with, or similar to one or more approaches described herein, a WTRU may be configured with a maximum and minimum number of SNs and may perform conditional SN addition and/or release such that it remains within the configured range of the number of SNs. The configured maximum and/or minimum may be determined explicitly (based on RRC configuration), or may be derived from other factors described herein, such as the load, bearer configuration, etc.

In some cases, a WTRU may indicate the SCHs added/changed following CPAC. The WTRU may indicate the SCGs added/removed/changed following a CPA/CPC with multiple SCGs. Specifically, the WTRU may send an RRC message to the network (e.g., to the MCG) with an indication of the SCGs added/removed/changed. Such indication may contain an identifier that was configured with the SCG, either in the RRC configuration that added the SCG, or in the CPAC command.

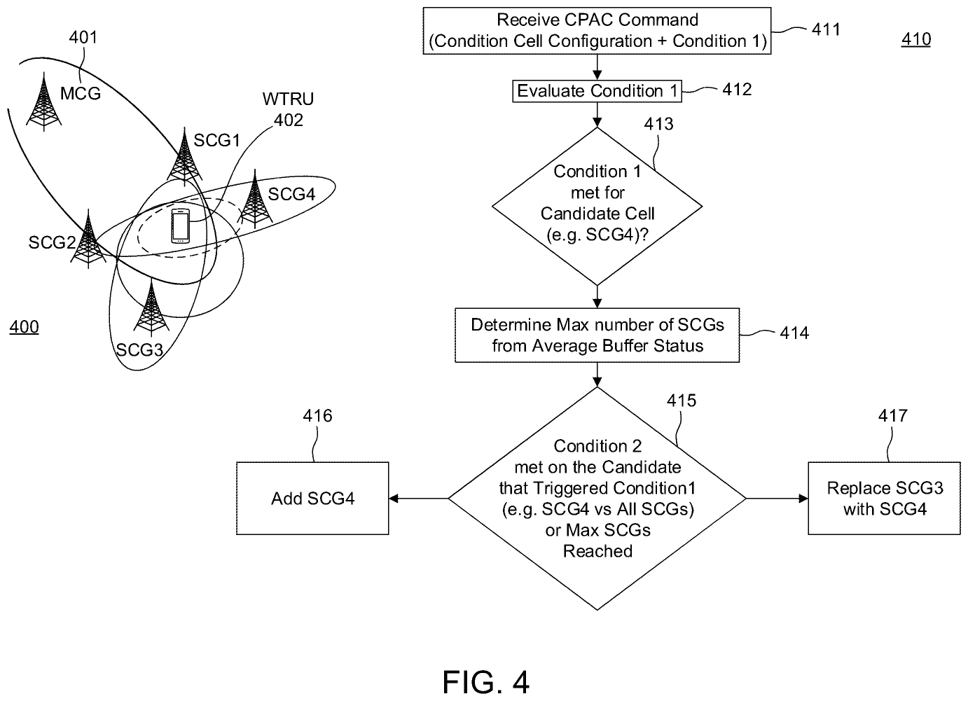

FIG. 4 illustrates an example of a CPAC command configuration and action (e.g., add, replace, removed, changed, etc.). As shown, there may be a scenario (e.g., 400) where a WTRU 402 may be within one or more cell groups, such as MCG 401, SCG1, SCG2, SCG3, and/or SCG4. There may be a corresponding process that is implemented by a WTRU (e.g., 410). According to one or more techniques described herein, at 411, a WTRU may be configured with a CPAC command comprising one or more candidate cell configurations and one or more conditions. For purposes of this example, the candidate cell corresponds to SCG4. The candidate cell configuration may be provided to the WTRU in a way that the WTRU can perform either SCG addition or SCG change. For instance, the WTRU may be provided with a full RRCconfiguration, or may be provided with multiple delta configurations on top of existing SCGs configured at the WTRU.

At 412, the WTRU may evaluate a first condition (e.g., condition 1, related to the candidate cell); the evaluation may occur periodically, dynamically, etc. At 413, when the condition for CPAC is met (e.g., condition 1) for the candidate cell (e.g., SCG4), the WTRU may determine whether to perform SCG addition or SCG change. Said another way, the WTRU may determine that a CPAC is triggered. In some instances, the WTRU may proceed to perform SCG addition or SCG change at this point (not shown); in the event that the CPAC is performed, the WTRU may in some instances report the change.

At 414, the WTRU may determine the maximum number of SCGs that can be active at the WTRU. This determination may be performed based on an average computed buffer status report (BSR) at the WTRU over a period of time. For example, the WTRU may be configured with a time period and with a mapping between the average BSR for all cell groups during the configured time period and a corresponding maximum number of SCGs.

At 415, the WTRU may use the maximum number of SCGs as well as an additional condition (e.g., condition 2) to determine whether to add the candidate cell (e.g., SCG4, the cell that triggered the CPAC condition 1) or replace an SCG with the candidate cell. Specifically, if the maximum number of SCGs determined by the WTRU is reached (e.g., the WTRU is already configured with the maximum number of SCGs), or condition 2 is met, the WTRU may replace, at 417, an SCG with the candidate cell (e.g., SCG3 with SCG4). The WTRU may determine the additional condition (e.g., condition 2) based on the quality of the candidate cell compared to one or more other SCGs (e.g., all). Specifically, at the time the candidate cell triggers the first condition, if the candidate cell is at least a threshold better than all other configured SCGs (e.g., where the WTRU may be configured with such threshold), the WTRU may replace the cell in question with the candidate cell. The WTRU may determine that the cell in question is the SCG having the lowest quality of all configured SCGs, which is why it should be replaced.

In some cases, following the decision to replace a cell or to add a cell, at 417 or 416 respectively, the WTRU may report the SCGs added/changed SGC(s) to the network. For example, the WTRU may report the change of SCGs, such as from SCG3 to SCG4. Alternatively, the WTRU may report the list of configured/active SCGs following the execution of the CPAC. The WTRU may send such a report as an RRC message to the MCG.

According to one or more techniques described herein, in one example, a WTRU may determine whether to perform Conditional Cell Addition/Change (CPA or CPC) based on relative measurements of the candidate cell that fulfilled one or more triggering conditions associated with the measurement event and a buffer status dependent maximum number of SCGs. A WTRU implements a method. The WTRU may receive configuration information including at least one candidate secondary cell group (SCG), wherein the configuration information includes a first set of conditions for an SCG addition or an SCG change. The WTRU may perform a first analysis including determining, based on one or more of the first set of conditions, that the SCG addition or the SCG change has to be performed, and determining a maximum number of active configured SCGs that can be configured from a total average buffer status of all active configured SCGs at the WTRU. Based on the first analysis and on a second set of conditions, the WTRU may perform an SCG change by replacing the weakest SCG with the at least one candidate SCG, wherein the second set of conditions includes a condition that the at least one candidate SCG is at least an offset better than all active configured SCGs, or the maximum number of active configured SCGs is reached. Based on the first analysis and a third set of conditions, the WTRU may perform an SCG addition by adding the at least one candidate SCG, wherein the third set of conditions includes a condition that the at least one candidate SCG is not at least an offset better than all active configured SCGs, and the maximum number of active configured SCGs is not reached. The WTRU may perform data transmission to the added or changed SCG, using the configuration information. The WTRU may send a transmission to an MCG indicating the added or changed SCG. The one or more conditions may be absolute or relative offsets/thresholds. Each SCG may include one PScell and one or more Scells, and the PScell may be used as the basis for all determinations and may be used for any measurements performed, as described herein. This example may also correspond to one or more illustrations of FIG. 4.

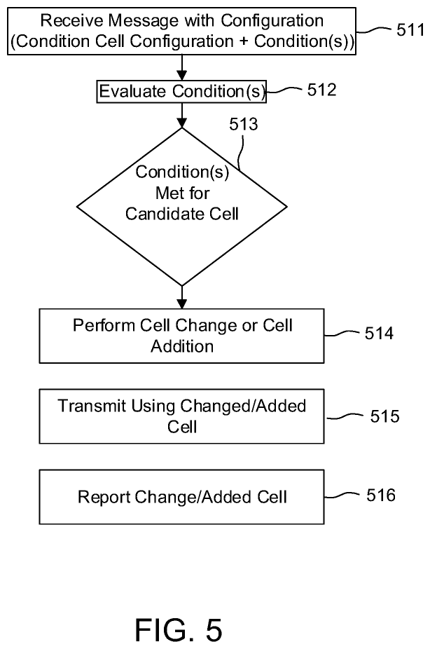

FIG. 5 illustrates an example of a CPAC configuration and action.

FIG. 5 illustrates an example of a CPAC configuration and action. According to one or more techniques described herein, at 511, a WTRU may receive a message, where the message may include one or more candidate cell configurations and one or more conditions. The candidate cell(s) configuration may be provided to the WTRU in a way that the WTRU can perform either SCG addition or SCG change. For instance, the WTRU may be provided with a full RRCconfiguration, or may be provided with multiple delta configurations on top of existing SCGs configured at the WTRU.

At 512, the WTRU may evaluate one or more conditions (e.g., related to the candidate cell); the evaluation may occur periodically or dynamically. At 513, when the one or more conditions is met, the WTRU may determine whether to perform SCG addition or SCG change. Said another way, the WTRU may determine that a CPAC is triggered. At 514, the WTRU may proceed to perform SCG addition or SCG change. In some instances, the WTRU report the change at 515 (e.g., to the MCG).

According to one or more techniques described herein, in one example, a WTRU determines whether to perform CPA or CPC based on the relative measurements of the candidate cell that fulfilled the triggering conditions for a measurement event. The WTRU is configured with a conditional addition or change (CPAC) command such that: the WTRU is configured with candidate SCG configurations that may serve as either an additional SCG or a replacement of an already existing SCG; the WTRU is configured with conditions (e.g., absolute or relative offsets/thresholds) to trigger a CPAC; if the candidate cell that triggered the event is at least an offset better than all of the serving PSCells, then the WTRU performs a PSCell change by replacing the weakest PSCell with the new candidate PSCell, otherwise, the WTRU performs a PSCell addition by adding the candidate cell as an additional PSCell; and/or, the WTRU performs data transmission to the added/changed PSCell(s), using the candidate configuration(s) provided in the CPAC command

According to one or more techniques described herein, in one example, a WTRU is configured with candidate cells that may be used for either addition or change of an SCG and selects the weakest PSCell to replace in case of change. The WTRU is configured with a conditional addition or change (CPAC) command such that: the WTRU is configured with candidate SCG configurations that can serve as either an additional SCG or a replacement of an already existing SCG; the WTRU is configured with one condition for CPA and another for CPC (e.g., absolute or relative offsets/thresholds); if a candidate cell fulfills the CPC condition, then the WTRU performs a PSCell change by replacing the weakest PSCell with the new candidate PSCell, otherwise if a candidate fulfills the CPA condition, then the WTRU performs a PSCell addition by adding the candidate cell as an additional PSCell; and/or, the WTRU performs data transmission to the added/changed PSCell(s), using the candidate configuration(s) provided in the CPAC command.

According to one or more techniques described herein, in one example, a WTRU determines the number of cells to add in a CPA command based on the relative measurements between the candidate cell that triggered the event and the current serving cells, and the event type. The WTRU is configured with a CPA command where: CPA is triggered when the number of candidate PSCells with quality above a threshold is larger than a configured value; if the quality of the best candidate cell which triggered the event is an offset better than any other cell which triggered the event, then the WTRU performs CPA for that PSCell only, otherwise, the WTRU performs CPA for all PSCells that triggered the event; and/or, the WTRU performs data transmission to the added PSCell(s), using the candidate configuration(s) provided in the CPA command.

Similar to the techniques described herein, there may be Conditional PSCell Addition/Change (CPAC) for Multiple SN scenario. Generally, in at least one example described herein there may be a scenario where measurements and corresponding actions are performed by the WTRU when a condition associated with the measurement(s) is satisfied and/or is used in the context of CPAC. Specifically, the measurements considered may be measurements of serving cells and/or neighboring cells. CPAC candidates may be configured at the WTRU using a message including a conditioned requirement, such as a CPAC command. The WTRU may decide whether to add an SCG, replace an SCG, etc. based on an occurrence of a measurement event (e.g., a trigger), and/or specific conditions described herein.

In some cases, there may be candidate cell maintenance for enabling L1/L2 Mobility. Using the techniques and approaches described herein with respect to conditional actions, similar approaches and techniques may be applicable to L1/L2 mobility. For example, there may be measurements and corresponding actions by the WTRU when a condition associated with the measurement is satisfied and is used in the context of candidate cell maintenance for L1/L2 mobility. Specifically, the WTRU may maintain a set of cell configurations, and a subset of the cell configurations may be considered as candidate cells. The WTRU behavior associated with candidate cells may be one or more of the following: the WTRU has the configuration, or a portion of the RRC configuration applied; the WTRU is configured with a common configuration that applies to all candidate configurations, or all configurations of cells in the set; the WTRU performs downlink synchronization to the candidate cells (e.g., the WTRU acquires the DL timing of the candidate cell); the WTRU performs uplink synchronization to the candidate cells (e.g., the WTRU may perform RACH to a candidate cell to acquire the UL timing, possibly if the candidate cell is not timing aligned with a serving cell); and/or, the WTRU monitors PDCCH on the candidate cell, potentially with a different monitoring configuration, search space configuration, beam configuration, etc. (e.g., the WTRU may be able to monitor PDCCH on the candidate cell, but not monitor/decode PDSCH on the candidate cell).

In some instances, the set of cell configurations and the candidate cells may be cells associated with the MCG or the SCG.

In one example, “serving cell” as used herein may refer to a candidate cell in the L1/L2 mobility scenario, while “neighbor cell” as used herein may refer to a non-candidate cell in the set of cell configurations maintained by the WTRU.

In one example, “serving cell” as used herein may refer to the actual serving cell and “neighbor cell” as used herein may refer to a candidate cell in the L1/L2 mobility context.

In one example, “serving cell” as used herein may refer to any cell in the set of cell configurations, and “neighbor cell” as used herein may refer to any cell measured via RRM which is not part of the set of maintained cell configurations.

In one example, a “CPAC candidate” as used herein may refer to a cell in the set of cell configurations maintained by the WTRU, and “executing the CPAC” (e.g., or the like) as used herein may refer to adding or replacing a cell in the subset of candidate cell configurations with the “CPAC candidate cell”.

As described herein, a higher layer may refer to one or more layers in a protocol stack, or a specific sublayer within the protocol stack. The protocol stack may comprise of one or more layers in a WTRU or a network node (e.g., eNB, gNB, other functional entity, etc.), where each layer may have one or more sublayers. Each layer/sublayer may be responsible for one or more functions. Each layer/sublayer may communicate with one or more of the other layers/sublayers, directly or indirectly. In some cases, these layers may be numbered, such as Layer 1, Layer 2, and Layer 3. For example, Layer 3 may comprise of one or more of the following: Non-Access Stratum (NAS), Internet Protocol (IP), and/or Radio Resource Control (RRC). For example, Layer 2 may comprise of one or more of the following: Packet Data Convergence Control (PDCP), Radio Link Control (RLC), and/or Medium Access Control (MAC). For example, Layer 3 may comprise of physical (PHY) layer type operations. The greater the number of the layer, the higher it is relative to other layers (e.g., Layer 3 is higher than Layer 1). In some cases, the aforementioned examples may be called layers/sublayers themselves irrespective of layer number, and may be referred to as a higher layer as described herein. For example, from highest to lowest, a higher layer may refer to one or more of the following layers/sublayers: a NAS layer, a RRC layer, a PDCP layer, a RLC layer, a MAC layer, and/or a PHY layer. Any reference herein to a higher layer in conjunction with a process, device, or system will refer to a layer that is higher than the layer of the process, device, or system. In some cases, reference to a higher layer herein may refer to a function or operation performed by one or more layers described herein. In some cases, reference to a high layer herein may refer to information that is sent or received by one or more layers described herein. In some cases, reference to a higher layer herein may refer to a configuration that is sent and/or received by one or more layers described herein.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method implemented by a wireless transmit receive unit (WTRU), the method comprising:
receiving configuration information including at least one candidate secondary cell group (SCG), wherein the configuration information includes a first set of conditions for triggering an SCG modification, wherein the SCG modification is performing an SCG addition, wherein the configuration information includes a second set of conditions, wherein the second set of conditions includes a condition that the at least one candidate SCG is not at least an offset better than all active configured SCGs, and wherein the second set of conditions includes a condition that a maximum number of active configured SCGs is not reached;
determining that the SCG modification is triggered for a first candidate SCG of the at least one candidate SCGs based on one or more of the first set of conditions;
based on determining the SCG modification is triggered, determining the first candidate SCG satisfies the second set of conditions;
based on satisfying the second set of conditions, performing the SCG modification, wherein the SCG modification adding the first candidate SCG; and
transmitting a message to the first candidate SCG.

2. The method of claim 1, further comprising sending a transmission to a Master Cell Group (MCG) indicating the first candidate SCG.

3. The method of claim 1, wherein the maximum number of active configured SCGs that can be configured is based on a total average buffer status of all active configured SCGs at the WTRU.

4. The method of claim 1, wherein one or more of the first set of conditions is absolute or relative offsets/thresholds.

5. The method of claim 1, wherein each SCG includes a PScell and one or more Scells, and wherein the PScell is used for all determinations and measurements.

6. The method of claim 1, wherein the first set of conditions includes where a neighboring cell becomes an offset better than a SpCell.

7. The method of claim 1, wherein the one or more of the first set of conditions are related to radio quality.

8. A wireless transmit receive unit (WTRU), the WTRU comprising:
a processor operatively coupled to a transceiver, wherein the processor and transceiver are configured to receive configuration information including at least one candidate secondary cell group (SCG), wherein the configuration information includes a first set of conditions for triggering an SCG modification, wherein the SCG modification is preforming an SCG addition, wherein the configuration information includes a second set of conditions, wherein the second set of conditions includes a condition that the at least one candidate SCG is not at least an offset better than all active configured SCGs, and wherein the second set of conditions includes a condition that a maximum number of active configured SCGs is not reached;
the processor and transceiver are configured to determine that the SCG modification is triggered for a first candidate SCG of the at least one candidate SCG based on one or more of the first set of conditions;
based on determining the SCG modification is triggered, the processor and transceiver are configured to determine determining the first candidate SCG satisfies the second set of conditions;
based on satisfying the second set of conditions, the processor and transceiver are configured to perform the SCG modification, wherein the SCG modification includes adding the first candidate SCG; and
the processor and transceiver are configured to transmit a message to the first candidate SCG.

9. The WTRU of claim 8, the processor and transceiver are configured to send to a Master Cell Group (MCG) indicating the first candidate SCG.

10. The WTRU of claim 8, wherein maximum number of active configured SCGs that can be configured is based on a total average buffer status of all active configured SCGs at the WTRU.

11. The WTRU of claim 8, wherein one or more of the first set of conditions is absolute or relative offsets/thresholds.

12. The WTRU of claim 8, wherein each SCG includes a PScell and one or more Scells, and wherein the PScell is used for all determinations and measurements.

13. The WTRU of claim 8, wherein the first set of conditions includes where a neighboring cell becomes an offset better than a SpCell.

14. The WTRU of claim 8, wherein one or more of the first set of conditions are related to radio quality.
